(19) United States
(12) Patent Application Publication
(10) Pub. No.: US 2006/0030205 A1
(43) Pub. Date: Feb. 9, 2006

(54) Connector for flexible printed circuit

(75) Inventors: Chi Zhang, Kunsan (CN); Ren-Chih Li, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/120,600

(22) Filed: May 2, 2005

(30) Foreign Application Priority Data
Aug. 5, 2004 (CN) 2004200784627

(51) Int. Cl. H01R 12/24

(52) U.S. Cl. 439/492

(57) ABSTRACT

An connector (100) for a flexible printed circuit (FPC) includes a first housing (1) having a tongue plate(12), a pair of arms (13) disposed beside the tongue plate respectively, and retention spaces (16) defined between the tongue plate and each arm; a second housing (4) movably assembled to the first housing, and having two opposite sidewalls (45) and a bottom wall between the sidewalls, the bottom wall facing the tongue plate to form a cavity therebetween for receiving the FPC (6), the sidewall configured to slide into the retention space to be retained therein with an upper surface and an under surface thereof exposed to exterior; and terminals arranged in the cavity to engage with the FPC.

### BACKGROUND OF THE INVENTION

1. Field of the Invention

The present invention relates to an electrical connector, and more particularly to an electrical connector for a sheet-like connection member such as a flexible printed circuit or cable (FPC), a flexible flat cable (FFC) and so forth. All of these cables and circuit will be generally referred to as “FPC”. The instant application relates to a contemporaneously filed application having the same title, the same applicant and the same assignee with the invention.

2. Description of Related Art

U.S. Pat. No. 5,816,845 discloses a connector for a FPC comprising a stationary housing defining a cavity with an insertion port through which the FPC is inserted into the cavity; metal terminals mounted on the housing and inserted into the cavity; and a slide housing displaceable relative to the housing between a completely-retained position and a provisionally-retained position. When the FPC is to be inserted into the cavity, the slide housing is displaced to the provisionally-retained position to be held in a stand-by position outwardly of the insertion port. After the FPC is inserted into the cavity, the slide housing is also inserted into the cavity to the completely-retained position, to hold the metal terminals in contact with the FPC. In addition, the stationary housing has a pair of U-shaped frame respectively at its lengthwise sides. Each frame comprises an upper flange, a lower flange, and a guide groove between the upper flange and the lower flange for guidingly receiving an arm of the movable housing to retain the movable housing on the stationary housing. The groove has a vertical size between the upper flange and the lower flange substantially equal to the thickness of the arm.

As the requirement of minimization of electrical components is ever increasing, it is desired to decrease the thickness of the connector. However, for preventing the arm of the movable housing from snapping, we should not decrease the thickness of arm to achieve that purpose. Thereby we can only decrease the thickness of the upper flange and the lower flange, but which will weaken the flanges. Otherwise, such a connector requires the stationary housing to provide a sufficient size of height to define a cavity to receive the FPC and the slide housing.

Thereby, to meet the ever-increasing requirement of minimization of electrical components, a connector with a lower profile for FPC is desired.

### SUMMARY OF THE INVENTION

An object of the present invention is to provide an electrical connector that is decreased in size of height for a FPC.

A second object of the present invention is to provide an electrical connector, parts of which are firmly assembled against accidental separating.

Accordingly, to achieve the above object, a connector of present invention includes a first housing having a tongue plate, a pair of arms disposed beside the tongue plate respectively, and retention spaces defined between the tongue plate and each arm; a second housing movably assembled to the first housing, and having two opposite sidewalls and a bottom wall between the sidewalls, the bottom wall facing the tongue plate to form a cavity therebetween for receiving the FPC, the sidewall configured to slide into the retention space to be retained therein with an upper surface and an under surface thereof exposed to exterior; and terminals arranged in the cavity to engage with the FPC.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an exploded view of a connector of the present invention;

FIG. 2 is an exploded view of the connector of FIG. 1 but taken from reversed aspect;

FIG. 3 is an assembled view of the connector of the present invention, showing a movable housing in a provisionally-retained position relative to a stationary housing of the connector and a FPC being aslant inserted into the connector;

FIG. 4 is an assembled view of the connector of the present invention, showing the movable housing in a completely-retained position relative to the stationary housing of the connector, wherein the FPC has been urged to contact terminals in the stationary housing;

FIG. 5 is a cross-sectional view taken along line 5-5 of FIG. 3; and

FIG. 6 is a cross-sectional view taken along line 6-6 of FIG. 4.

### DETAILED DESCRIPTION OF THE INVENTION

Reference will now be made to the drawing figures to describe the present invention in detail.

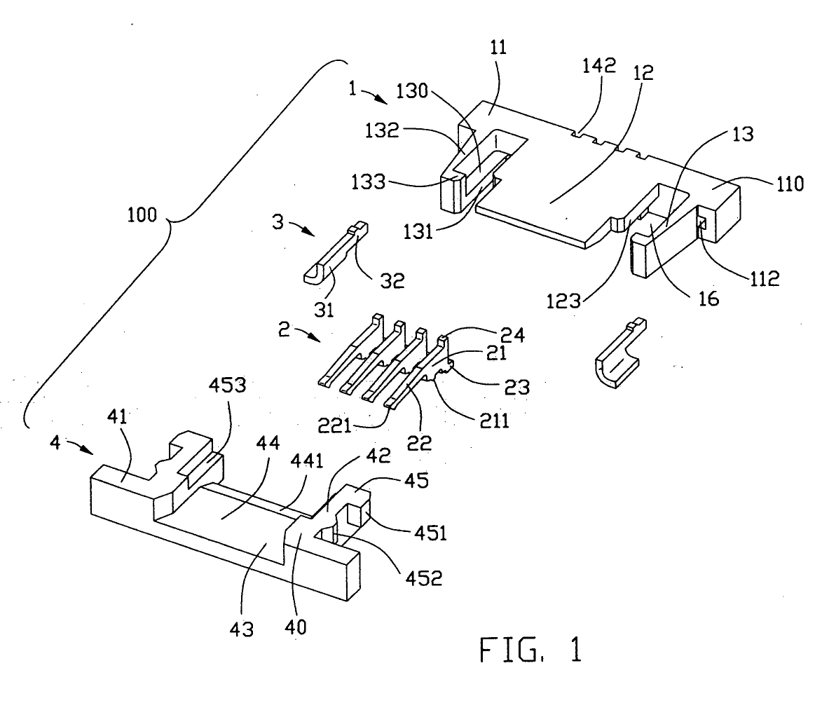

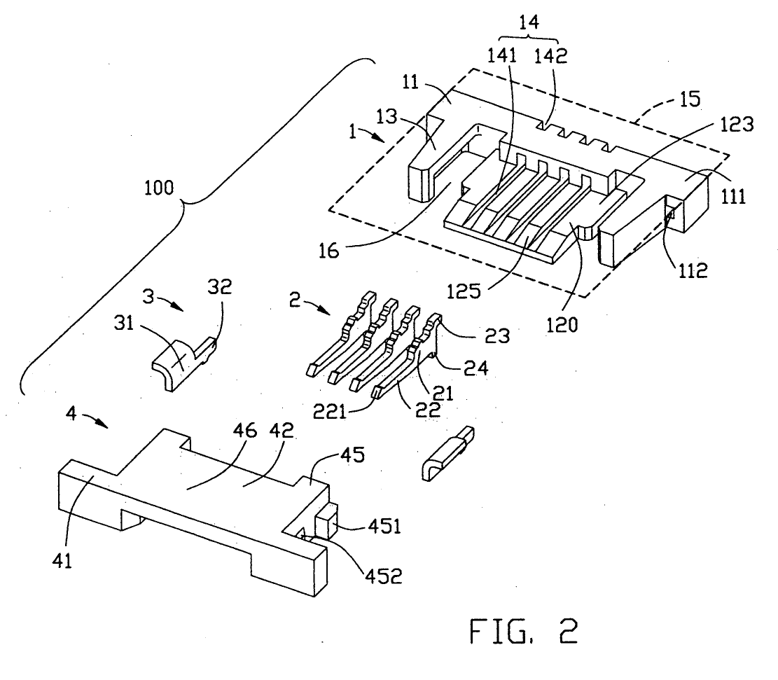

Referring to FIGS. 1 and 2, the connector 100 of the present invention comprises a stationary housing 1, terminals 2 to be arranged in the stationary housing 1, retainers 3, and a movable housing 4.

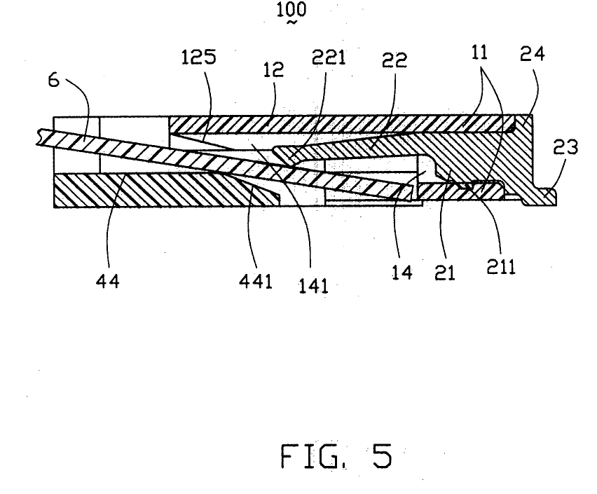

The stationary housing 1 has a lengthwise body portion 11, a tongue plate 12 breadthwise extending from the body portion 11 with its upper surface flush with an upper surface 110 of the body portion 11, and a pair of arms 13 oppositely beside the tongue plate 12 and extending from the body portion 11 with its upper surface and under surface respectively flush with the upper surface 110 and under surface 111 of the body portion 11. The under surface 111 of the body portion 11 defines a suppositional mounting face 15 for mounting on a printed circuit board (PCB) (not shown). The tongue plate 12 has a first mating surface 120 facing the mounting face 15 with a vertical distance therebetween and defines a plurality of interior slots 141 on the first mating surface 120. Each interior slot 141 extends breadthwise throughout the body portion 11 to communicating a respective exterior slot 142 defined along a vertical direction, to form a unitary aperture 14 to receive the terminals 2. Additionally, the tongue plate 12 is trimmed to form a shortened edge 123. The first mating surface 120 inclines at that end remote from the body portion 11 to form a first slant 125, as best shown in FIG. 5. The arm 13 defines a recess 130 opening up and communicating with a space 16 between the arm 13 and the tongue plate 12.

The terminal 2 comprises a retention portion 21, an elastic arm 22 extending from one end of the retention portion 21, a solder tail 23 and a stop tail 24 respectively extending down and up from the other end of the retention portion 21. The elastic arm 22 has a contact portion 221 at the end thereof. The retention portion 21 has a retain leg 211 protruding downwards to be retained in the body portion 11 of the stationary housing 1.

Referring to FIG. 5 together, the terminal 2 is inserted into the aperture 14 from the exterior slot 142 with its elastic arm 22 received in the interior slot 141 and protruding towards the mounting face 15. The stop tail 24 is blocked in the exterior slot to stop the terminal 2 from moving ahead. The solder tail 23 is to be soldered to the PCB.

The retainers 3 each comprise an elbow 31 to be soldered to the PCB, and a leg 32 to be fixed into a hole 112 in the stationary housing 1 adjacent to the outside of the arm 13 (shown in FIG. 1). Thus the retainers 3 retain stationary housing 1 to the PCB to prevent the tongue plate 12 thereof from turning up during insertion of a FPC or the movable housing 4.

The movable housing 4 being of a “T” shape comprises a lengthwise body portion 41 and a mating portion 42 perpendicularly extending from the body portion 41, and is cut from an upper surface 40 thereof to define a passage 43 therein extending along a breadthwise direction throughout the body portion 41 and the mating portion 42. That bottom surface 44 of the passage 43 functions as a second mating surface and sidewalls 45 of the passage 43 function as slide legs. The second mating surface 44 declines at that end remote from the body portion 41 to form a second slant 441. Each slide leg 45 has a first slide block 451 and a second slide block 452 spaced protruding from its outer side, and defines a notch 453 by its inner side to engage the shortened edge 123 while the slide leg 45 is sliding into the space 16 of the stationary housing 1.

The movable housing 4 is assembled to the stationary housing 1 with an under surface 46 thereof sliding along the mounting face 15. Meanwhile the slide leg 45 slides into the space 16 with the slide blocks 451,452 thereof being forced into the recess 130 in succession, and the notch 453 thereof fittingly engaging the shortened edge 123. Thus the slide blocks 451,452 are hold in the recess 130 by a bottom flange 131 thereof, to prevent the movable housing 4 from dropping down. The engagement of the notch 453 and the shortened edge 123 stops the movable housing 4 from moving up, thereby to keep a space between first mating surface 120 and the second mating surface 44 to form a cavity for receive the FPC. Otherwise, as the slide blocks 451,452 are hold in the recess 130, and are stopped from sidewalking by a side flange 132 thereof, from overly advancing by the body portion 11 exposed in the recess 130 and acting as an end flange, and from withdrawing by another end flange 133 thereof, the slide leg 42 therefore is retained in the space 16.

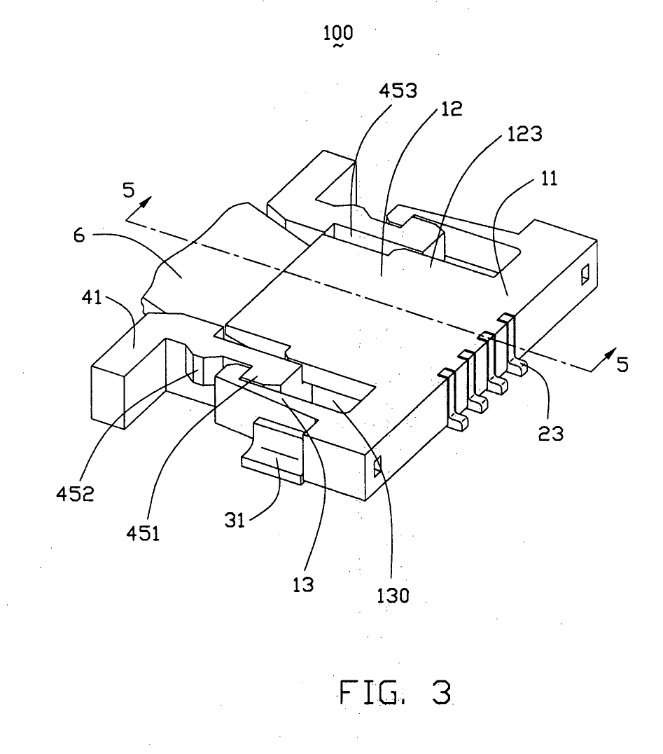

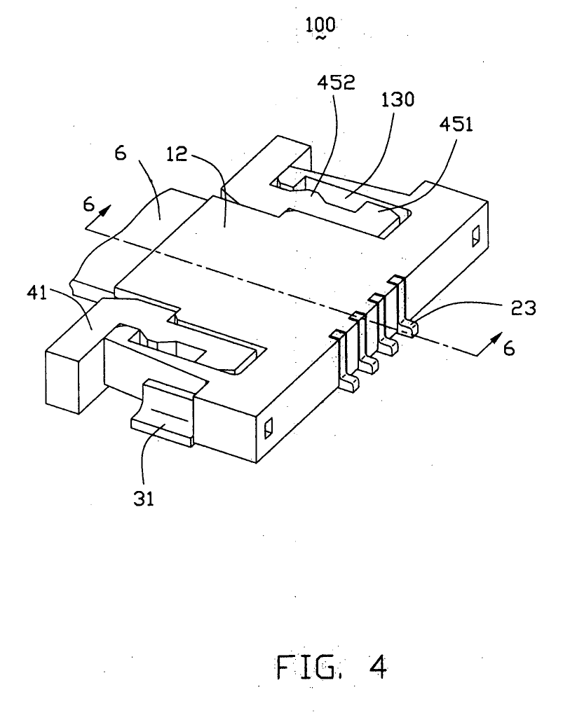

The movable housing 4 has a size of height equal to that of the stationary housing 1 as a whole. Thus the slide leg 45 in the space 16 is upwards and downwards exposed to exterior, making the upper surface and the under surface of the movable housing 4 be flush with that of the stationary housing 1, as shown in FIG. 3 or 4. That effectively retrenches the whole height of the connector 100. Again, since the PCB is instead of a bottom wall of the stationary housing 1 to form a room for receiving the FPC 6 and the movable housing 4 together with the tongue plate 12, a height size of the bottom wall is saved on the stationary housing 1, which also decreases the whole height of the stationary housing 1.

Referring to FIGS. 3 and 5, when the first slide block 451 is forced into the recess 451 but the second slide block 452 is still left out, the movable housing 4 is located in a provisionally-retained position relative to the stationary housing 1. At this time, the second slant 441 of the second mating surface 44 is brought into being parallel to the first slant 125 of the first mating surface 120 to form a slantwise insertion-port for guiding a FPC 6 to enter into the cavity between the first mating surface 120 and the second mating surface 44. Thus the FPC 6 is aslant inserted through the insertion-port with a zero insertion force. As a result of the insertion of the movable housing 4 or the FPC 6, the tongue plate 12 of the stationary housing 1 would be turned up if the stationary housing 1 is attached to the PCB only by the terminals 2 therein being soldered to the PCB. However, the existence of the retainers 3 further retains stationary housing 1 to the PCB against turning up of the tongue plate 12.

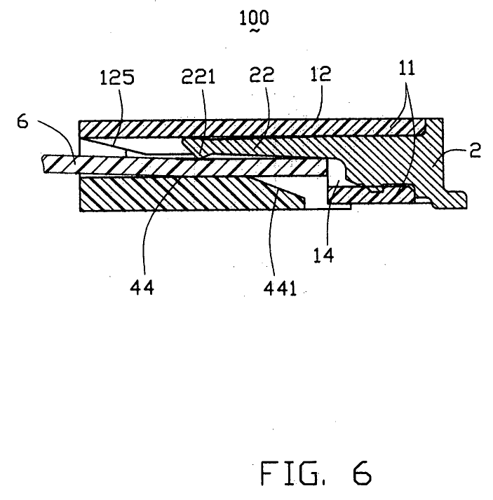

After the FPC 6 is inserted into the cavity, the movable housing 4 is further inserted towards the stationary housing 1, and the second slide block 452 is also forced into the recess 130. Now the movable housing 4 is in a completely-retained position, as shown in FIGS. 4 and 6. The second mating surface 44 of the advancing movable housing 4 urges the FPC 6 to rotate from the slanting state to a flat state to tightly contact the contact portions 221 of the terminals 2. That ensures electrical connection between conductors of the FPC 6 and the terminals 2.

Therefore, by such a design, an electrical connector with a lower profile for FPC is provided. However, the disclosure is illustrative only, changes may be made in detail, especially in matter of shape, size, and arrangement of parts within the principles of the invention.

What is claimed is:

1. A connector for a flexible printed circuit (FPC) comprising:
a first housing having a tongue plate, a pair of arms disposed beside the tongue plate respectively, and retention spaces defined between the tongue plate and each arm;
a second housing movably assembled to the first housing and having two opposite sidewalls and a bottom wall between the sidewalls, the bottom wall facing the tongue plate to form a cavity therebetween for receiving the FPC, the sidewall having an upper surface and an under surface and being retained in the retention space with the upper surface and the under surface thereof exposed outwardly; and
terminals arranged in the cavity for engaging with the FPC.

2. The connector as described in claim 1, wherein the first housing comprises a body portion joining the tongue plate and the arms.

3. The connector as described in claim 2, wherein the body portion extends along a direction perpendicular to the tongue plate and defines an under surface vertically spaced from the tongue plate.

4. The connector as described in claim 1, wherein the arm defines a recess opening upward and communicating with the retention space, and wherein the sidewall of the second housing has a bulge portion interferentially engaged with the recess to be held therein.

5. The connector as described in claim 4, wherein the bulge portion comprises two tubers protruding from outer side of the sidewall and spaced in a direction along which the second housing is assembled to the first housing.

6. The connector as described in claim 5, wherein the tongue plate of the first housing defines a first slant and the bottom wall of the second housing defines a second slant, the second slant being substantially parallel to the first slant to form an FPC insertion port when only one of the tubers on the sidewall mates with the recess.

7. The connector as described in claim 1, wherein the sidewall defines a notch to fittingly receive a lateral edge of the tongue plate.

8. The connector as described in claim 1, further comprising a retainer adapted to fasten the first housing to a printed circuit board (PCB), and comprising one end fixed to the first housing and another end adapted to be soldered to the PCB.

9. A connector for a flexible printed circuit (FPC) comprising:
a first insulative housing defining an upper tongue plate; and
a second insulative housing assembled to the first housing and moveable relative to the first housing along a front-to-back direction between a first position and a second position, said second housing defining a lower bottom wall, said lower bottom wall being vertically overlapped under the upper tongue when said second housing is located in a first position but offset from said upper tongue with a distance in said front-to-back direction at the second position so as to allow said second insulative housing to be assembled to the first housing in a downward direction initially at said second position; wherein
the first housing defines a first downward surface and a first upward surface, and the second housing defines a second upward surface engaged with the first downward surface and a second downward surface engaged with the first upward surface for preventing relative movement between the first housing and the second housing when said second housing is located at the first position.

10. The connector as claimed in claim 9, wherein said second upward surface and said first downward surface are not engaged with each other when said second housing is located in the second position so as to allow the second housing is upwardly moveable relative to the first housing at said second position for removal from the first housing.

11. The connector as claimed in claim 9, wherein the first housing defines first front and rear engaging surfaces, and said second housing defines second front and rear engaging surfaces cooperating with said first front and rear engaging surfaces to restrain movement of said second housing relative to the first housing between said first and second positions in said front-to-back direction.

12. The connector as claimed in claim 9, wherein a plurality of contacts disposed in the first housing.

13. The connector as claimed in claim 11, wherein said first housing defines a pair of side arms by two sides of the tongue, and said first housing defines said first front and rear engaging surfaces.

14. The connector as claimed in claim 11, wherein said second housing defines a pair of side arms by two sides of the bottom wall, and said second housing defines said second front and rear engaging surfaces.

15. The connector as claimed in claim 14, wherein said pair of side arms are exposed upwardly to an exterior when said second housing is located in the first position.

16. A method of assembling a connector for a flexible printed circuit, comprising the steps of:
providing a first insulative housing with a forward upper tongue and a upward engaging surface;
disposing a plurality of contacts in the first housing for mounting to a printed circuit board;
providing a second insulative housing with a rearward lower bottom wall and a downward engaging surface;
initially downwardly assembling the second housing unto the first housing when said second connector is located in an outer position relative to the first housing until engagement occurs between the upward engaging surface and the downward engaging surface; and
successively rearwardly moving the second housing relative to the first housing until the second housing reaches an inner position relative to the first housing; wherein
said first housing further includes a downward engaging surface and the second housing further includes an upward engaging surface engaged with the downward engaging surface of the first housing when said second housing is located in the inner position so as to prevent upward withdrawal of the second housing from the first housing.

17. The method as claimed in claim 16, wherein said bottom wall and said tongue commonly defines a cavity for receiving a flexible printed circuit, when said second housing is located in the inner position.

18. The method as claimed in claim 16, wherein said first housing defines a pair of first side arms by two sides of the tongue, and the second housing defines a pair of second side arms by two sides of the bottom wall, and wherein said second side arms are upwardly exposed to an exterior when said second housing is located in the inner position.

19. The method as claimed in claim 16, wherein the first housing defines first front and rear engaging surfaces, and said second housing defines second front and rear engaging surfaces cooperating with said first front and rear engaging surfaces to restrain movement of said second housing relative to the first housing between said first and second positions in said front-to-back direction.
